(19) United States
(12) Patent Application Publication
(10) Pub. No.: US 2024/0259862 A1
(43) Pub. Date: Aug. 1, 2024

(54) E2E QoS WITH SIDELINK RELAY

(71) Applicant: Fraunhofer-Gesellschaft zur Foerderung der angewandten Forschung e.V., Munich (DE)

(72) Inventors: Mehdi HAROUNABADI, Erlangen (DE); Dariush MOHAMMAD SOLEYMANI, Erlangen (DE); Martin LEYH, Erlangen (DE); Elke ROTH-MANDUTZ, Erlangen (DE); Dietmar LIPKA, Erlangen (DE); Shubhangi BHADAURIA, Erlangen (DE); Gustavo Wagner OLIVEIRA DA COSTA, Erlangen (DE); Bernhard NIEMANN, Erlangen (DE)

(21) Appl. No.: 18/394,597

(22) Filed: Dec. 22, 2023

Related U.S. Application Data
(63) Continuation of application No. PCT/EP2022/067978, filed on Jun. 29, 2022.

(30) Foreign Application Priority Data
Jun. 30, 2021 (EP) 21182910.6

(51) Int. Cl. H04W 28/02; H04L 47/10; H04W 88/04; H04W 92/18

(52) U.S. Cl. CPC H04W 28/0268; H04L 47/18; H04W 28/0263; H04W 88/04; H04W 92/18

(57) ABSTRACT

Embodiment provide a transceiver of a wireless communication system, wherein the transceiver is configured to operate in a sidelink in-coverage, out of coverage or partial coverage scenario, wherein the transceiver is configured to operate, in dependence on a QoS and/or QoS requirement of the transceiver, using a selected configuration out of a set of configurations.

### CROSS-REFERENCES TO RELATED APPLICATIONS

This application is a continuation of copending International Application No. PCT/EP2022/067978, filed Jun. 29, 2022, which is incorporated herein by reference in its entirety, and additionally claims priority from European Application No. EP 21 182 910.6, filed Jun. 30, 2021, which is incorporated herein by reference in its entirety.

### BACKGROUND OF THE INVENTION

Embodiments of the present application relate to the field of wireless communication, and more specifically, to wireless communication between a user equipment and a base station via a sidelink relay. Some embodiments relate to E2E (end-to-end) QoS with sidelink relay.

FIG. 1 is a schematic representation of an example of a terrestrial wireless network 100 including, as is shown in FIG. 1 (a), a core network 102 and one or more radio access networks RAN1, RAN2, . . . RANN. FIG. 1 (b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In a wireless communication system as described above, a reduction of a latency of QoS (QOS=quality of service) management is crucial [1], especially when signals are relayed by a sidelink relay between a UE and a gNB.

Conventionally, QoS configurations are sent by the gNB to the remote UE and relaying UE, and the gNB should be informed in case of any dynamics in the network. This leads to a high latency in QoS management.

Therefore, there is the need of reducing the latency of QoS management.

It is noted that the information in the above section is only for enhancing the understanding of the background of the invention and therefore it may contain information that does not form conventional technology and is already known to a person of ordinary skill in the art.

### SUMMARY

An embodiment may have a transceiver of a wireless communication system, wherein the transceiver is configured to operate in a sidelink in-coverage, out of coverage or partial coverage scenario, wherein the transceiver is configured to operate, in dependence on a QoS and/or QoS requirement of the transceiver, using a selected configuration.

Another embodiment may have a relaying transceiver of a wireless communication system, wherein the relaying transceiver is configured to operate in a sidelink in-coverage, out of coverage or partial coverage scenario, wherein the relaying transceiver is configured to relay signals between a transceiver and a base station or another transceiver of the wireless communication system, wherein the relaying transceiver is configured to operate, in dependence on a QoS or/and QoS requirement of the transceiver, using a selected configuration.

Another embodiment may have a base station of a wireless communication system, wherein the base station is configured to serve a plurality of transceivers, wherein the base station is configured to communicate with a transceiver via a relaying transceiver of the wireless communication system, wherein the base station is configured to provide a configuration or a set of configurations to the transceiver and/or relaying transceiver, or to update or reconfigure at least a part of configurations of the set of configurations in the transceiver or relaying transceiver, or to select and signal a configuration of the set of configurations to be used by the transceiver and/or relaying transceiver in dependence on a reported QoS requirement of the transceiver.

Another embodiment may have a wireless communication system, comprising: a transceiver, a relaying transceiver, and a base station according to the invention.

Another embodiment may have a method for operating a transceiver of a wireless communication system, wherein the method comprises: operating the transceiver in a sidelink in-coverage, out of coverage or partial coverage scenario, operating the transceiver, in dependence on a QoS and/or QoS requirement of the transceiver, using a selected configuration.

Another embodiment may have a method for operating a relaying transceiver of a wireless communication system, wherein the method comprises: operating the relaying transceiver in a sidelink in-coverage, out of coverage or partial coverage scenario, relaying signals between a transceiver and a base station or another transceiver of the wireless communication system, wherein the signals are relayed between the transceiver and the base station, in dependence on a QoS or/and QoS requirement of the transceiver, using a selected configuration.

Another embodiment may have a method for operating a base station of a wireless communication system, the method comprising: communicating with a transceiver via a relaying transceiver of the wireless communication system, wherein the method further comprises providing a configuration or a set of configurations to the transceiver and/or to the relaying transceiver, or updating or reconfiguring at least a part of configurations of the set of configurations in the transceiver or in the relaying transceiver, or selecting and signaling a configuration of the set of configurations to be used by the transceiver and/or the relaying transceiver in dependence on a reported QoS requirement of the transceiver.

Another embodiment may have a non-transitory digital storage medium having a computer program stored thereon to perform the method for operating a transceiver of a wireless communication system, wherein the method comprises: operating the transceiver in a sidelink in-coverage, out of coverage or partial coverage scenario, operating the transceiver, in dependence on a QoS and/or QoS requirement of the transceiver, using a selected configuration, when said computer program is run by a computer.

### BRIEF DESCRIPTION OF THE DRAWINGS

Embodiments of the present invention will be detailed subsequently referring to the appended drawings, in which:

FIG. 1a-b shows a schematic representation of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a wireless communication system comprising a transceiver, like a base station or a relay, and a plurality of communication devices, like UEs, according to an embodiment;

FIG. 7 is a schematic representation of a data flow between a remote UE, relaying UE and gNB for QoS management by the gNB; and

FIG. 8 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

As indicated above, a reduction of a latency of QoS (QOS=quality of service) management is crucial [1], especially when signals are relayed by a sidelink relay between a UE and a gNB. The QoS management in L2 relay is described in [2]. Specifically, in [2] the general QoS handling for L2 UE-to-Network Relay is studied. The gNB implementation can handle the QoS breakdown over Uu and PC5 for end-to-end QoS enforcement, and this breakdown can be flexibly tailored to the AS conditions on sidelink and Uu. Details of handling in case PC5 RLC channels with different E2E QoS are mapped to the same Uu RLC channel. The end-to-end QoS enforcement can be supported. In case of OOC, Remote UE operates using the configuration provided in SIB or dedicated RRC signaling with overall better QoS performance than using pre-configuration. QoS can be enforced for each bearer as the gNB can decide whether an E2E bearer is admitted or not depending on the current congestion.

Moreover in [3], the QoS control with L2 relay is described. As shown in Annex A of [3], the NAS endpoints between a Remote UE and the network are as currently specified such that the operation via a UE-to-Network Relay UE should be transparent to the network NAS, with the exception of authorization/provisioning identified in clause 6.7.2.4. This means that the 5GS flow-based QoS concept in particular should be reused between the Remote UE and the network, with necessary adaptation over the radio interface, i.e. PC5 (for the Remote UE and UE-to-Network Relay UE) and Uu (for the UE-to-Network Relay UE). RAN performs QoS enforcement for PC5 interface and Uu interfaces when it gets QoS profile from the CN. For example, RAN performs QoS enforcement with AS layer configuration with necessary adaptation over PC5 interface and Uu interface. In other words, QoS flows established between the network and the Remote UE will be mapped to PC5 “radio bearers” seen by the Remote UE and to normal Uu radio bearers seen by the network, whereby the UE-to-Network Relay UE performs the necessary adaptation between Uu and PC5. Thereby, how to perform AS layer configuration for PC5 interface and Uu interface depends on RAN.

In [4], the QoS support by L2 UE-to-Network relay is described. Traffic of one or multiple evolved ProSe Remote UEs may be mapped to a single DRB of Uu interface of the evolved ProSe UE-to-Network Relay UE. Multiple Uu DRBs may be used to carry traffic of different QoS classes, for one or multiple evolved ProSe Remote UEs. It is also possible to multiplex traffic of evolved ProSe UE-to-Network Relay UE itself onto the Uu DRB, which is used to relay traffic to/from evolved ProSe Remote UEs. How the mapping of the traffic between sidelink bearers and Uu bearers is done is up to the eNB implementation and the mapping is configured in evolved ProSe UE-to-Network Relay UE by the eNB. An adaptation layer over Uu is supported to identify the evolved ProSe Remote UE/evolved ProSe UE-to-Network Relay UE and the corresponding bearer.

Embodiments described herein allow for reducing the latency of QoS management.

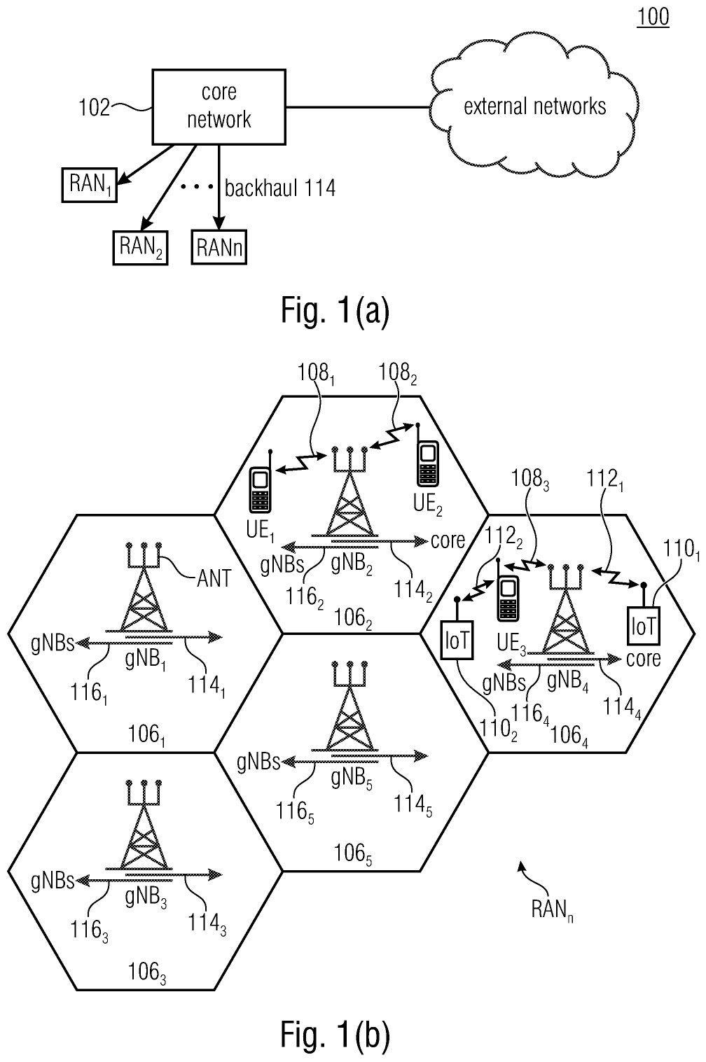

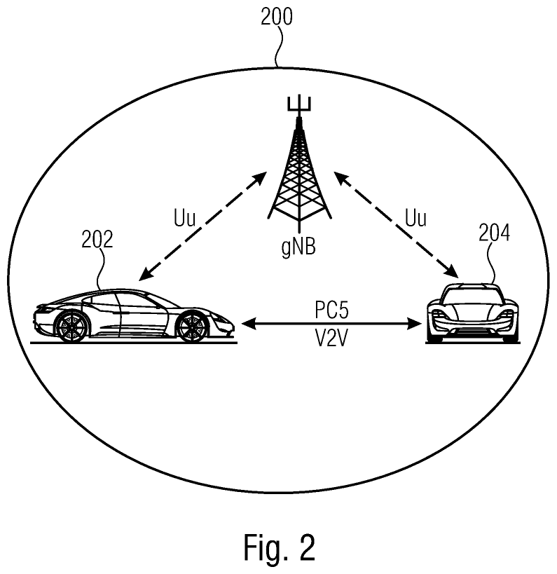

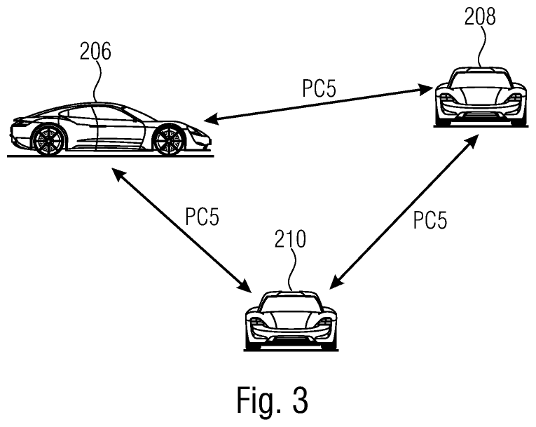

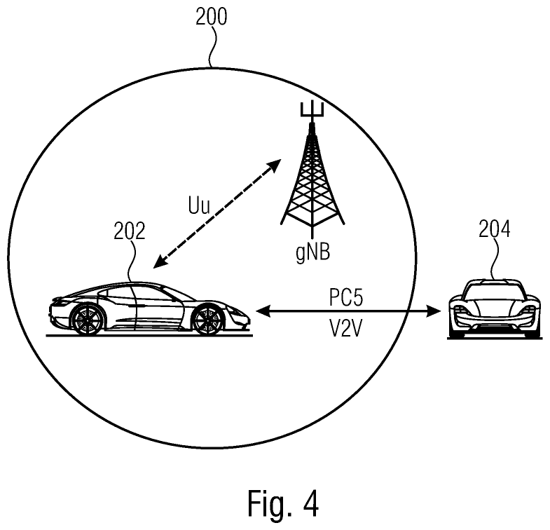

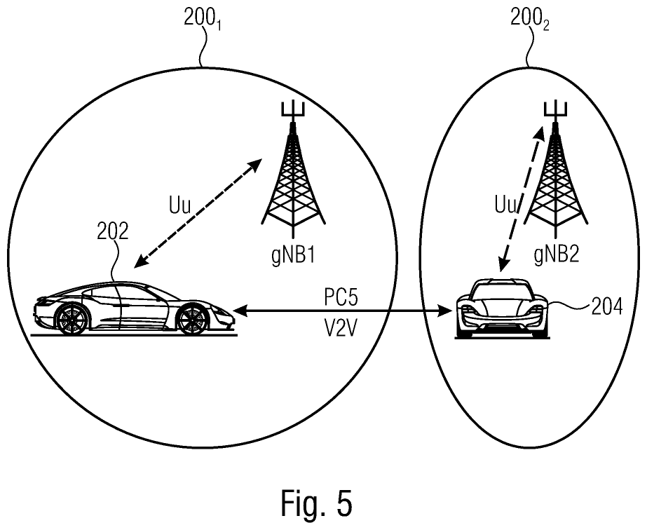

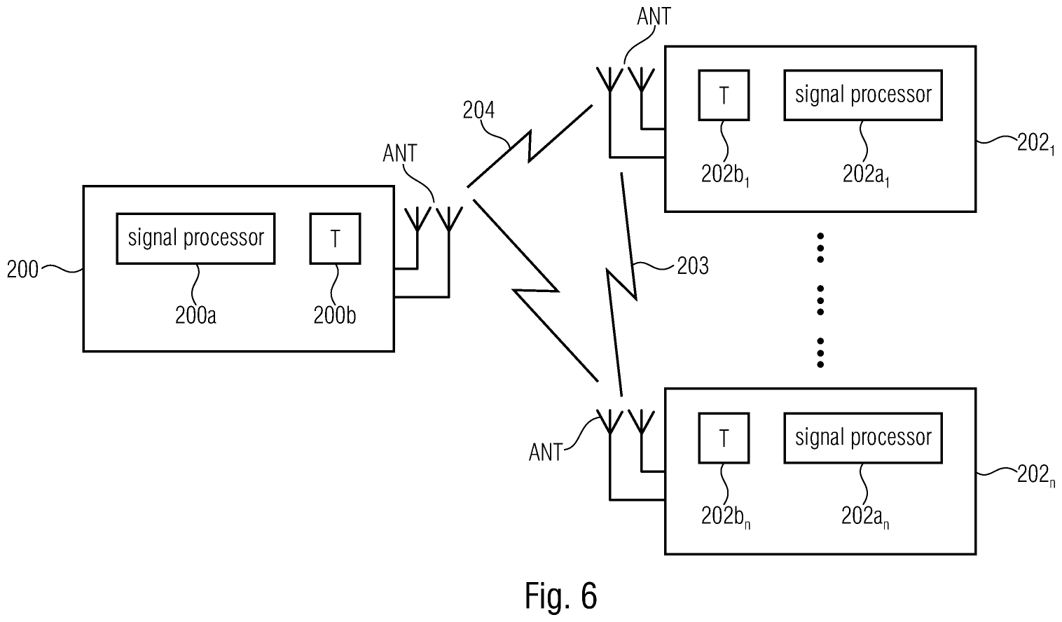

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 6 is a schematic representation of a wireless communication system comprising a transceiver 200, like a base station or a relay, and a plurality of communication devices 202₁ to 202ₙ, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202an, and a transceiver (e.g., receiver and/or transmitter) unit 202b1 to 202bn. The base station 200 and/or the one or more UEs 202 may operate in accordance with the inventive teachings described herein.

Embodiments provide a transceiver [e.g., remote UE] of a [e.g., new radio, NR/5G] wireless communication system, wherein the transceiver is configured to operate in a sidelink in-coverage, out of coverage or partial coverage scenario [e.g., to operate in a NR sidelink mode 1 or mode 2]], wherein the transceiver is configured to operate [e.g., transmit and/or receive signals], in dependence on a [e.g., current or predicted] QoS [QoS=Quality of Service] and/or QoS requirement of the transceiver, using a selected configuration [e.g., QoS configuration].

In embodiments, the transceiver is configured to receive the selected configuration from a relaying transceiver or a base station of the wireless communication network.

In embodiments, the transceiver is configured to receive the selected configuration via a configuration message [e.g., RRC reconfiguration message].

In embodiments, the selected configuration complies with the QoS requirement of the transceiver.

In embodiments, the selected configuration includes a PC5 [channel] configuration and/or a Uu [channel] configuration.

In embodiments, the selected configuration defines a mapping between Uu and PC5 radio bearers.

In embodiments, the selected configuration is selected out of a set of configurations.

In embodiments, at least a proper subset of configurations of the set of configurations are associated with different QoS requirements of the transceiver.

In embodiments, at least a proper subset of configurations of the set of configurations are associated with different communication conditions [e.g., transceiver conditions, channel conditions, relaying transceiver conditions, base station conditions].

In embodiments, the transceiver is configured to report the [e.g., current] QoS requirement to a relaying transceiver [e.g., relaying UE] or a base station of the wireless communication network.

In embodiments, the transceiver is configured to report the QoS requirement
event based,
periodically,
threshold based,
responsive to a reporting request [e.g., from the relaying transceiver or the base station,
responsive to QoS requirements.

In embodiments, the transceiver is configured to select a configuration out of the set of configurations itself in dependence on the [e.g., current] QoS requirement of the transceiver, to obtain the selected configuration,

In embodiments, the transceiver is configured to predict a future QoS or/and QoS requirement and/or channel variation and to select the configuration out of the set of configurations itself in dependence on the predicted QoS and/or QoS requirement and/or channel variations and/or transceiver condition [e.g. traffic load], to obtain the selected configuration,

In embodiments, the transceiver is configured to select a configuration out of the set of configuration indicated/signaled by a relaying transceiver or base station or another transceiver of the wireless communication system, to obtain the selected configuration.

In embodiments, each configuration [e.g., QoS configuration] of the set of configurations [e.g., QoS configurations] defines a mapping between Uu and PC5 radio bearers.

In embodiments, the QoS requirement is at least one out of
latency [e.g., packet delay budget],
data rate,
reliability [e.g., packet error rate],
different data flows or resource types [e.g., guaranteed bit rate, GBR],
priority level.

In embodiments, the transceiver is configured to transmit and/or receive signals to and/or from a relaying transceiver or base station of the wireless communication system [e.g., via the relaying transceiver] using the selected configuration.

In embodiments, the set of configurations [e.g., QoS configurations] are stored in a memory of the transceiver.

In embodiments, the set of configurations [e.g., QoS configurations] are provided to the transceiver by a relaying transceiver [e.g., relaying UE] or base station [e.g., gNB] of the wireless communication network.

In embodiments, the transceiver is configured to update and/or reconfigure one or more configurations of the set of configurations [e.g., QoS configurations] responsive to a reception of a [e.g., QoS] update and or reconfiguration information.

In embodiments, the transceiver is configured to report its operating status to a relaying transceiver or a base station of the wireless communication system.

In embodiments, the operating status includes at least one out of
a channel busy ratio, CBR, and/or channel occupancy rate, CR at the transceiver,
a load of the transceiver,
a buffer status of the transceiver,
a queueing latency [e.g., max, min, and/or mean queueing latency] of the transceiver,
a packet error rate of the transceiver,
a number of HARQ retransmissions of the transceiver,
a measurement report of the transceiver.

In embodiments, the transceiver is configured to report its operating status
event based,
periodically,
threshold based, or
responsive to an operating status reporting request [e.g., from the relaying transceiver or the base station].

In embodiments, the transceiver is configured to perform a radio resource selection in dependence on a queuing information reported by a relaying transceiver of the wireless communication system.

In embodiments, the transceiver is configured to report a packet delay budget to a relaying transceiver of the wireless communication system.

Further embodiments provide a transceiver [e.g., remote UE] of a [e.g., new radio, NR/5G] wireless communication system, wherein the transceiver is configured to operate in a sidelink in-coverage, out of coverage or partial coverage scenario [e.g., to operate in a NR sidelink mode 1 or mode 2]], wherein the transceiver is configured to operate [e.g., transmit and/or receive signals], in dependence on a [e.g., current or predicted] QoS [QoS=Quality of Service] and/or QoS requirement of the transceiver, using a selected configuration [e.g., QoS configuration] out of a set of configurations [e.g., QoS configurations].

Further embodiments provide a relaying transceiver [e.g., relaying UE] of a [e.g., new radio, NR/5G] wireless communication system, wherein the relaying transceiver is configured to operate in a sidelink in-coverage, out of coverage or partial coverage scenario [e.g., NR sidelink mode 1 or mode 2]], wherein the relaying transceiver is configured to relay signals between a transceiver and a base station or another transceiver of the wireless communication system, wherein the relaying transceiver is configured to operate [e.g., transmit and/or receive signals], in dependence on a [e.g., current or predicted] QoS or/and QoS requirement of the transceiver, using a selected configuration [e.g., QoS configuration].

In embodiments, the relaying transceiver is configured to receive the selected configuration from a base station of the wireless communication network.

In embodiments, the relaying transceiver is configured to receive the selected configuration via a configuration message [e.g., RRC reconfiguration message].

In embodiments, the relaying transceiver is configured to relay the selected configuration to the transceiver.

In embodiments, the selected configuration complies with the QoS requirement of the transceiver.

In embodiments, the selected configuration includes a PC5 [channel] configuration and/or a Uu [channel] configuration.

In embodiments, the selected configuration defines a mapping between Uu and PC5 radio bearers.

In embodiments, the selected configuration is selected out of a set of configurations

In embodiments, the [e.g., current] QoS requirement is reported from the transceiver [e.g., remote UE] to the relaying transceiver.

In embodiments, the relaying transceiver is configured to report the QoS requirement of the transceiver [e.g., remote UE] to the base station.

In embodiments, the relaying transceiver is configured to report its own QoS requirement to the base station.

In embodiments, the relaying transceiver is configured to combine the QoS requirement of the transceiver [e.g., remote UE] and its own QoS requirement, in order to obtain a combined QoS requirement, and to report the combined QoS requirement to the base station.

In embodiments, the relaying transceiver is configured to select a configuration out of the set of configurations in dependence on the [e.g., current] QoS requirement of the transceiver, to obtain the selected configuration.

In embodiments, the relaying transceiver is configured to predict a future QoS and/or QoS requirement of the transceiver and to select the configuration out of the set of configurations in dependence on the predicted QoS and/or QoS requirement, to obtain the selected configuration,

In embodiments, the relaying transceiver is configured to signal the selected configuration to the transceiver.

In embodiments, the relaying transceiver is configured to relay signals between the transceiver and the base station using the selected configuration.

In embodiments, the relaying transceiver is configured to provide the set of configurations to the transceiver.

In embodiments, the relaying transceiver is configured to determine at least a part of the set of configurations itself, and/or wherein the set of configurations are provided to the relaying transceiver by the base station.

In embodiments, the relaying transceiver is configured to update and/or reconfigure one or more configurations of the set of configurations in the transceiver.

In embodiments, the relaying transceiver is configured to update and/or reconfigure one or more configurations of the set of configurations in the transceiver
periodically,
event based [e.g., .CBR threshold, geo-location, change in the speed, direction of mobility of the transceiver], or
responsive to a request for reconfiguration received from the transceiver.

In embodiments, the relaying transceiver is configured to receive an operating status report from the transceiver.

In embodiments, the operating status includes at least one out of
a channel busy ratio, CBR, and/or channel occupancy rate, CR at the transceiver,
a load of the transceiver,
a buffer status of the transceiver,
a queueing latency [e.g., max, min, and/or mean queueing latency] of the transceiver,
a packet error rate of the transceiver,
a number of HARQ retransmissions of the transceiver,
a measurement report of the transceiver.

In embodiments, the relaying transceiver is configured to relay the operating status report of the transceiver to the base station.

In embodiments, the relaying transceiver is configured to determine at least a part of the set of configurations or to update and/or reconfigure one or more configurations of the set of configurations based on the received operating status report.

In embodiments, the relaying transceiver is configured to report its operating status to the base station of the wireless communication system.

In embodiments, the operating status includes at least one out of
a channel busy ratio, CBR, and/or channel occupancy rate, CR at the relaying transceiver,
a load of the relaying transceiver,
a buffer status of the relaying transceiver,
a queueing latency [e.g., max, min, and/or mean queueing latency] of the relaying transceiver,
a packet error rate of the relaying transceiver,
a number of HARQ retransmissions of the relaying transceiver,
a measurement report of the relaying transceiver.

In embodiments, the relaying transceiver is configured to report its operating status
event based,
periodically,
threshold based, or
responsive to an operating status reporting request [e.g., from the base station].

In embodiments, the relaying transceiver is configured to report a queuing information to the transceiver.

In embodiments, the relaying transceiver is configured, when relaying, to prioritize signals of the transceiver in dependence on a delay budget reported by the transceiver.

In embodiments, the relaying transceiver is configured to reject a relaying of a signal itself when a relaying rejection criterion is fulfilled.

In embodiments, the relaying rejection criterion is at least one out of
a maximum number of served transceivers on PC5 is exceeded,
an overload of Uu link,
a limited processing capability of the relaying transceiver,
a not supported QoS class,
a battery level of the relaying transceiver falls below a threshold.

In embodiments, the relaying transceiver is configured to receive a QoS parameter from the base station, the QoS parameter describing a headroom in the Uu capacity of the base station, wherein the relaying rejection criterion is fulfilled when the headroom in the Uu capacity is exhausted.

Further embodiments provide a relaying transceiver [e.g., relaying UE] of a [e.g., new radio, NR/5G] wireless communication system, wherein the relaying transceiver is configured to operate in a sidelink in-coverage, out of coverage or partial coverage scenario [e.g., NR sidelink mode 1 or mode 2]], wherein the relaying transceiver is configured to relay signals between a transceiver and a base station or another transceiver of the wireless communication system, wherein the relaying transceiver is configured to operate [e.g., transmit and/or receive signals], in dependence on a [e.g., current or predicted] QoS or/and QoS requirement of the transceiver, using a selected configuration [e.g., QoS configuration] out of a set of configurations [e.g., QoS configurations].

Further embodiments provide a base station [e.g., gNB] of a [e.g., new radio, NR/5G] wireless communication system, wherein the base station is configured to serve a plurality of transceivers, wherein the base station is configured to communicate with a transceiver via a relaying transceiver of the wireless communication system, wherein the base station is configured
to provide a configuration [e.g., QoS configuration] or a set of configurations [e.g., QoS configurations] to the transceiver and/or relaying transceiver,
or to update or reconfigure at least a part of configurations [e.g., QoS configurations] of the set of configurations [e.g., QoS configurations] in the transceiver or relaying transceiver,
or to select and signal a configuration [e.g., QoS configuration] of the set of configurations [e.g., QoS configurations] to be used by the transceiver and/or relaying transceiver in dependence on a reported QoS requirement of the transceiver.

In embodiments, the base station is configured to update and/or reconfigure one or more configurations of the set of configurations in the transceiver or relaying transceiver
periodically,
event based [e.g., .CBR threshold, geo-location, change in the speed, direction of mobility of the transceiver], or
responsive to a request for reconfiguration received from the transceiver or relaying transceiver.

In embodiments, the base station is configured to predict a future QoS or/and QoS requirement of the transceiver and to select and signal the configuration out of the set of configurations to be used by the transceiver and/or relaying transceiver in dependence on the predicted QoS or/and QoS requirement.

In embodiments, the base station is configured to receive an operating status report from the transceiver and/or relaying transceiver.

In embodiments, the operating status includes at least one out of
a channel busy ratio, CBR, and/or channel occupancy rate, CR at the transceiver or relaying transceiver,
a load of the transceiver or relaying transceiver,
a buffer status of the transceiver or relaying transceiver,
a queueing latency [e.g., max, min, and/or mean queueing latency] of the transceiver or relaying transceiver,
a packet error rate of the transceiver or relaying transceiver,
a number of HARQ retransmissions of the transceiver or relaying transceiver,
a measurement report of the transceiver or relaying transceiver.

In embodiments, the base station is configured to determine at least a part of the set of configurations or to update and/or reconfigure one or more configurations of the set of configurations based on the received operating status report.

In embodiments, the base station is configured to report a QoS parameter to the relaying transceiver, the QoS parameter describing a headroom in the Uu capacity of the base station.

Further embodiments provide a wireless communication system, comprising a transceiver according to one of the embodiments described herein, a relaying transceiver according to one of the embodiments described herein, and a base station according to one of the embodiments described herein.

Further embodiments provide a method for operating a transceiver [e.g., remote UE] of a [e.g., new radio, NR/5G] wireless communication system. The method comprises a step of operating the transceiver in a sidelink in-coverage, out of coverage or partial coverage scenario [e.g., to operate in a NR sidelink mode 1 or mode 2]]. Further, the method comprises a step of operating the transceiver, in dependence on a [e.g., current or predicted] QoS and/or QoS requirement of the transceiver, using a selected configuration [e.g., QoS configuration] [e.g., out of a set of configurations [e.g., QoS configurations]].

Further embodiments provide a method for operating a relaying transceiver [e.g., relaying UE] of a [e.g., new radio, NR/5G] wireless communication system. The method comprises a step of operating the relaying transceiver in a sidelink in-coverage, out of coverage or partial coverage scenario [e.g., NR sidelink mode 1 or mode 2]]. Further, the method comprises a step of relaying signals between a transceiver and a base station or another transceiver of the wireless communication system, wherein the signals are relayed between the transceiver and the base station, in dependence on a [e.g., current or predicted] QoS or/and QoS requirement of the transceiver, using a selected configuration [e.g., QoS configuration] [e.g., out of a set of configurations [e.g., QoS configurations]].

Further embodiments provide a method for operating a base station [e.g., gNB] of a [e.g., new radio, NR/5G] wireless communication system. The method comprises a step of communicating [e.g., transmitting and/or receiving signals] with a transceiver via a relaying transceiver of the wireless communication system. Further, the method comprises a step of
providing a configuration [e.g., QoS configuration] or a set of configurations [e.g., QoS configurations] to the transceiver and/or to the relaying transceiver,
or updating or reconfiguring at least a part of configurations [e.g., QoS configurations] of the set of configurations [e.g., QoS configurations] in the transceiver or in the relaying transceiver,
or selecting and signaling a configuration [e.g., QoS configuration] of the set of configurations [e.g., QOS configurations] to be used by the transceiver and/or the relaying transceiver in dependence on a reported QoS requirement of the transceiver.

Embodiments of the present invention enhance UE latency and reliability.

Subsequently, embodiment of the present invention are described in further detail.

### 1.1 Embodiment 1: In-Advance Configuration of PC5 and Uu Mapping for QoS Provisioning in Relay and Remote UE by a gNB or Relay UE

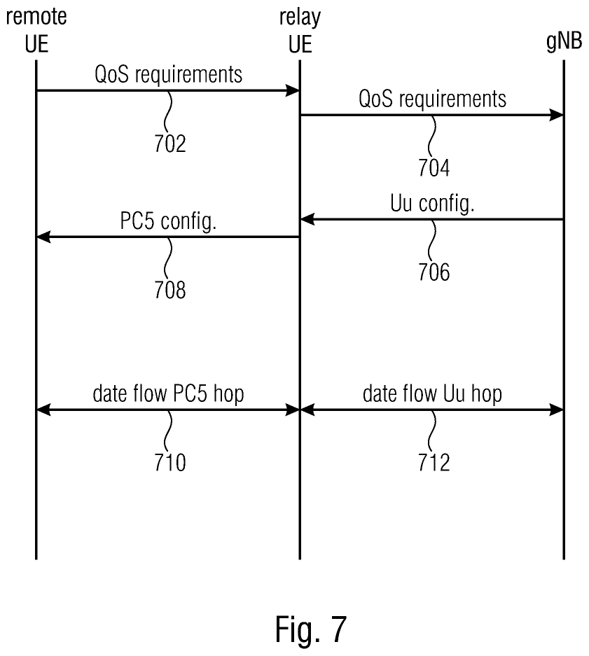

In embodiments, in case of L2 UE-to-Network, the QoS configurations can be sent/transmitted by a gNB to a remote UE and/or L2 relay node. In embodiments, the configurations comply with the QoS requirements of the data flows in the remote UE. The mapping between Uu and PC5 radio bearers can be performed (or done) based on the configurations provided by the gNB or/and relay UE. The gNB needs to receive relevant information about the traffic flows, their requirements, channels condition, etc. to provide such configurations. FIG. 7 shows the message sequence chart of QoS provision in L2 relay.

Specifically, FIG. 7 shows schematic representation of data flows between a remote UE, relaying UE and gNB for QoS management by the gNB. In a first step 702, the remote UE can sent an information describing its QoS requirements to the relay UE. In a second step 704, the relay UE can relay the information describing the QoS requirements of the remote UE or an updated version thereof (e.g., updated by its own QoS requirements) to the gNB. Naturally, the relay UE can also relay the information describing the QoS requirements of the remote UE and transmit a further information with its own QoS requirements to the gNB. In a third step 706, the gNB can transmit a respective configuration (Uu configuration and/or PC5 configuration) to the relay UE, wherein the relay UE can relay the respective configuration (e.g., at least the PC5 configuration) to the remote UE in a fourth step 708. Afterwards, in steps 710 and 712 data flow between the remote UE, relay UE and gNB is performed using the respective configuration.

Alternatively, in case of UE-to-UE Relay, the configurations can be sent by a relay UE to one or multiple remote UEs.

As can be seen in FIG. 7, the application of the appropriate configuration at remote and relay UEs, can be delayed due to reporting the requirements (and also channel conditions, etc.) from the UE and the reception of the configurations in the remote and relay UEs from gNB. For this reason, in case of fast variations of the channel and the data flow requirements, the required QoS may not be fulfilled.

To overcome this challenge, according to the inventive approach described herein, one or more out of the following embodiments might apply. Thereby, note that in case of UE-to-UE relay, a relay UE can take over some or all tasks of the gNB).

In embodiments, a gNB or relay UE can provide a set of configurations to the remote UE and/or relay UE to cover all or part of possible scenarios (e.g., QoS requirements, channel conditions, node condition, etc.). In this case, the reaction of the remote UE and relay UE is faster to the network dynamics.

In embodiments, a gNB or relay UE may consider possible variations in the QoS requirements and channel conditions in its configurations (e.g., allocation of redundant resources, etc.).

In embodiments, the network (e.g., a gNB) or the remote UE might learn channel variations and QoS requirements of the traffic flow and predict the future QoS. The decision on QoS configuration in the remote and relay UE might be based on a predictive QoS.

In embodiments, a gNB or relay UE might periodically update the configurations in the remote UE and/or relay UE. A set of configurations/QoS profiles may be pre-configured in the relay UE and remote UE, which may be used in case no configurations are provided by the gNB or the network or to reduce configuration overhead (i.e., selection from pre-configured QoS profile triggered via gNB).

In embodiments, a gNB or relay UE might update the configurations in the remote UE and/or relay UE based on a triggering event (e.g., CBR threshold, geo-location, change in the speed, direction of mobility of UEs, etc.).

In embodiments, a gNB (e.g., could be based on reports received from remote UE, which may include SL information), a remote UE, or relay UE might trigger re-configuration of QoS in the gNB.

In embodiments, a request for re-configuration might be sent by a remote UE or a relay UE, e.g., through a message (e.g., via PC5-RRC or RRC).

In embodiments, a relay UE may use its own experienced (part or all) possible conditions/scenarios (e.g., QoS requirements, channel conditions, node condition, etc.), assuming that these conditions may match to the remote UE. This could apply during the initiation phase to setup a relay or to reduce the latency or to reduce the (number of) reports sent from the remote UE to the relay UE. Relay UEs using its own conditions also for the remote UE may especially apply, if the relay and remote UEs may experiencing similar environmental conditions, e.g., relay UE and remote UE are in proximity and/or outdoor on the same road heading in the same direction or indoor in close proximity in the same room.

A gNB or relay UE may initiate (e.g., after successful discovery) or demand an update (periodically and/or event driven) of the configurations of the remote and/or relay UE using one or more of the following options:
discovery message adding an (optional) field;
discovery beacon in 1^{st} stage SCI;
in case of shared resource pool by adding an optional field in either 1^{st} stage or 2^{nd} stage SCI;
in case of dedicated resource pool by using a fixed reporting interval to send periodically relay specific report(s).

In embodiments, a gNB may provide one or a set of configurations to a relay UE, whenever a UE is setup/enabled/allowed to be used as a relay UE, i.e. once the network allows or enables a UE to function also as relay.

In embodiments, an alternative way for QoS pre-configuration is to assume the whole set of QoS characteristics or profiles, e.g., as specified in 3GPP TS 23.501. The selection of the most appropriate profile is then done with a well specified algorithm that is commonly known and used on all entities of the relay, i.e. gNB, relay and remote UE. If only one algorithm is specified not further action is needed. If a number of alternative algorithms is to be supported the gNB signals an identity or a small set of parameters of the algorithm instead of a set of configurations. In other words, the selection strategy for a configuration is provided rather than a set of configurations themselves. This can reduce signaling overhead, considerably.

### 1.2 Embodiment 2: Status Report by Remote UE and Relay UE to gNB

To assist a gNB to fulfill the QoS requirements of data flows by its QoS configurations, a relay UE, and remote UE should provide necessary information to the gNB. The relevant information to be used in the gNB for an e2e QoS configuration can be one or more out of:
CBR and CR at remote UE;
CBR and CR at relay UE;
load of the relay UE, optionally including additionally, e.g.,
   number of serving remote UE, and/or
   number of active PC5 links;
UE load—not related to relaying (optional),
   e.g., UE load status (overall), e.g., to indicate that this UE cannot serve as a relay for the given period in time due to load conditions;
buffer status report (BSR) of remote UE (similar to IAB BSR or SL BSR to be extended/adapted for relaying);
buffer status report of relay UE (similar to IAB BSR or SL BSR to be extended/adapted for relaying);
max, min, and/or mean queueing latency (e.g., time period in buffer until a packet is transmitted) at remote and relay UE;
packet error rate at relay/remote UE, i.e. channel conditions between relay UE and remote UE;
HARQ retransmissions at relay/remote UE if configured;
measurement reports relay/remote UE, i.e. RSSI, RSRP, CQI, CSI, e.t.c.

The above-mentioned reports and information can be sent from the relay or remote UE in one out of the following ways:
on event-based, and/or
periodic, and/or
based on exceeding a threshold (e.g., based on RSRP/RSSI or relative distance between relay and remote UE), and/or
based on report request from gNB or network.

A history of the above-mentioned reports and information can help to determine a suitable range of QoS characteristics, e.g., designated by a set of corresponding 5QI values. The length of the history can be confined, i.e. with a forgetting factor, to a reasonable range to avoid that the set of QoS characteristics would end up including the complete set, e.g., as specified in 3GPP TS 23.501, table 5.7.4-1.

### 1.3 Embodiment 3: Remote UE and Relay UE in Mode 2

In Mode 2, the radio resources are prioritized by the physical layer based on the application layer requirements, whereby different UEs may have different delay packet budgets. This way, additional delay due to queuing in relay node or additional propagation delay causes some packets to get expired upon receiving at gNB. To avoid such a situation, in embodiments, two mechanisms at the relay or remote node are devised.

According to a first mechanism, a relay UE may indicate its queue information to remote UE and thus remote UE may consider this additional delay for radio resource selection procedure. For example, the remote UE may select the resource slots within the selection window considering a delay value indicated by the relay UE or select those resources taken into consideration a delay offset capturing the expected delay indicated by the relay UE.

According to a second mechanism, remote UE may indicate its packet delay budget to the relay UE and the relay UE may use this information to prioritize its relayed data transmission towards gNB.

Thereby, the delay packet budget at the remote UE or queueing information at the relay UE can be exchanged by RRC or MAC or broadcast information, e.g., SIB.

### 1.4 Embodiment 4: Local Admission Control in Relay

In the typical QoS setup a flow may be rejected by the RAN or core network when the desired QoS level cannot be achieved.

In the sidelink relay operation, also the relay may have reasons to reject the flow (or in other, the relay may reject the flow when a predefined condition/criterion is met), such as, for example:
a maximum number of served UEs on PC5 is exceeded,
an overload of Uu link,
a limited processing capability of the relay,
not supported QoS class, and/or
a relay running out of battery.

In such cases, to save signaling and access time the relay itself shall be able to reject the flow immediately without the need to involve RAN or core network. In this way, as soon as the flow is rejected the remote UE will be able to retry with relaxed QoS conditions or search for a different relay.

The QoS request may be sent during PC5 connection establishment or after it.

In order to assist such local decision the gNB may provide a new QoS parameter to the relay, namely an EBR (Extension Bit rate). This refers to a headroom in Uu capacity for the relay. If the EBR is exhausted (e.g. 0), the relay may consider that the Uu link will not support any new flows and it will be able to reject a new flow even without relaying the message to the gNB. On the other hand, if the gNB provides an EBR value, the relay may signal to the remote UE a provisional acceptance of the requested QoS up to this data rate.

### 2. Further Embodiments

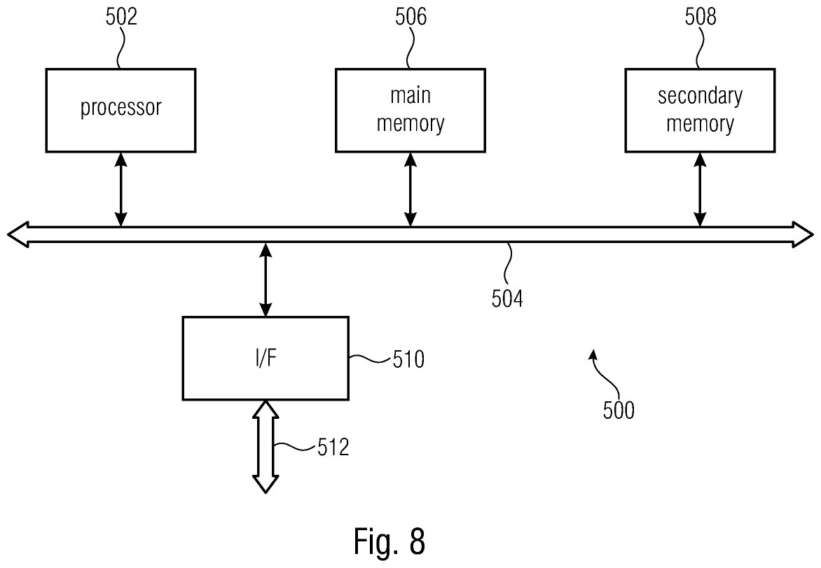

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 8 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The above described embodiments are merely illustrative for the principles of the present invention. It is understood that modifications and variations of the arrangements and the details described herein are apparent to others skilled in the art. It is the intent, therefore, to be limited only by the scope of the impending patent claims and not by the specific details presented by way of description and explanation of the embodiments herein.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### LIST OF REFERENCES

[1] RP-210904, New WID on NR Sidelink Relay, Ericsson
[2] TR 38.836 V1.0.0 (2020-12), Study on NR sidelink relay
[3] TR 23.752 V17.0.0 (2021-03), Study on system enhancement for Proximity based Services (ProSe) in the 5G System (5GS), (Release 17)
[4] TR 36.746 V2.0.1 (2017-09): Study on further enhancements to LTE Device to Device (D2D), User Equipment (UE) to network relays for Internet of Things (IoT) and wearables; (Release 15)

### ABBREVIATIONS

3GPP third generation partnership project
ACK acknowledgement
AIM assistance information message
AL alert limit
AMF access and mobility management function
ARAIM advanced receiver autonomous integrity monitoring
BS base station
BWP bandwidth part
CA carrier aggregation
CC component carrier
CBG code block group
CBR channel busy ratio
CQI channel quality indicator
CSI-RS channel state information-reference signal
CN core network
CR number of sub-channels occupied by a UE
D2D device-to-device
DAI downlink assignment index
DCI downlink control information
DL downlink
DRX discontinuous reception
FFT fast Fourier transform
FR1 frequency range one
FR2 frequency range two
GMLC gateway mobile location center
gNB evolved node B (NR base station)/next generation node B base station
GNSS global navigation satellite system
HAL horizontal alert limit
HARQ hybrid automatic repeat request
IoT internet of things
LCS location services
LMF location management function
LPP LTE positioning protocol
LTE long-term evolution
MAC medium access control
MCR minimum communication range
MCS modulation and coding scheme
MIB master information block
MO-LR mobile originated location request
MT-LR mobile terminated location request
NACK negative acknowledgement
NB node B
NI-LR network induced location request
NR new radio
NRPPa NR positioning protocol-annex
NTN non-terrestrial network
NW network
OFDM orthogonal frequency-division multiplexing
OFDMA orthogonal frequency-division multiple access
PBCH physical broadcast channel
P-UE pedestrian UE; not limited to pedestrian UE, but represents any UE with a need to save power, e.g., electrical cars, cyclists,
PC5 interface using the sidelink channel for D2D communication
PDCCH physical downlink control channel
PDSCH physical downlink shared channel
PL protection level
PLMN public land mobile network
PPP point-to-point protocol
PPP precise point positioning
PRACH physical random access channel
PRB physical resource block
PRS public regulated services (Galileo)
PSFCH physical sidelink feedback channel
PSCCH physical sidelink control channel
PSSCH physical sidelink shared channel
PUCCH physical uplink control channel
PUSCH physical uplink shared channel
PVT position and/or velocity and/or time
PVT position, velocity and time
RAIM receiver autonomous integrity monitoring
RAN radio access networks
RAT radio access technology
RB resource block
RNTI radio network temporary identifier
RP resource pool
RRC radio resource control
RS reference symbols/signal
RTK real time kinematics
RTT round trip time
SBAS space-based augmentation systems
SBI service based interface
SCI sidelink control information
SI system information
SIB sidelink information block
SL sidelink
SSR state space representations
TB transport block
TTI short transmission time interval
TDD time division duplex
TDOA time difference of arrival
TIR target integrity risk
TRP transmission reception point
TTA time-to-alert
TTI transmission time interval
UAV unmanned aerial vehicle
UCI uplink control information
UE user equipment
UL uplink
UMTS universal mobile telecommunication system
V2x vehicle-to-everything
V2V vehicle-to-vehicle
V2 vehicle-to-infrastructure
V2P vehicle-to-pedestrian
V2N vehicle-to-network
V-UE vehicular UE
VRU vulnerable road user

1. Transceiver of a wireless communication system,
wherein the transceiver is configured to operate in a sidelink in-coverage, out of coverage or partial coverage scenario,
wherein the transceiver is configured to operate, in dependence on a QoS and/or QoS requirement of the transceiver, using a selected configuration.

2. Transceiver according to claim 1,
wherein the transceiver is configured to receive the selected configuration from a relaying transceiver or a base station of the wireless communication network.

3. Transceiver according to claim 1,
wherein the transceiver is configured to receive the selected configuration via a configuration message.

4.-6. (canceled)

7. Transceiver according to claim 1,
wherein the selected configuration is selected out of a set of configurations,
and/or wherein the selected configuration is selected out of a set of configurations, wherein at least a proper subset of configurations of the set of configurations are associated with different QoS requirements of the transceiver,
and/or wherein at least a proper subset of configurations of the set of configurations are associated with different communication conditions.

8.-9. (canceled)

10. Transceiver according to claim 1,
wherein the transceiver is configured to report the QoS requirement to a relaying transceiver or a base station of the wireless communication network,
and/or wherein the transceiver is configured to report the QoS requirement to a relaying transceiver or a base station of the wireless communication network, wherein the transceiver is configured to report the QoS requirement
event based,
periodically,
threshold based,
responsive to a reporting request.
responsive to QoS requirements,
and/or wherein the transceiver is configured to select a configuration out of the set of configuration indicated/signaled by a relaying transceiver or base station or another transceiver of the wireless communication system, to acquire the selected configuration.

11.-15. (canceled)

16. Transceiver according to claim 1,
wherein the QoS requirement is at least one out of
latency,
data rate,
reliability,
different data flows or resource types,
priority level.

17. Transceiver according to claim 1,
wherein the transceiver is configured to transmit and/or receive signals to and/or from a relaying transceiver or base station of the wireless communication system using the selected configuration,
and/or wherein the set of configurations are stored in a memory of the transceiver or wherein the set of configurations are provided to the transceiver by a relaying transceiver or base station of the wireless communication network,
and/or wherein the transceiver is configured to update and/or reconfigure one or more configurations of the set of configurations responsive to a reception of a update and or reconfiguration information.

18.-19. (canceled)

20. Transceiver according to claim 1,
wherein the transceiver is configured to report its operating status to a relaying transceiver or a base station of the wireless communication system,
and/or wherein the wherein the transceiver is configured to report its operating status to a relaying transceiver or a base station of the wireless communication system, wherein the operating status includes at least one out of
a channel busy ratio, CBR, and/or channel occupancy rate, CR at the transceiver,
a load of the transceiver,
a buffer status of the transceiver,
a queueing latency of the transceiver,
a packet error rate of the transceiver,
a number of HARQ retransmissions of the transceiver,
a measurement report of the transceiver,
and/or wherein the transceiver is configured to report its operating status to a relaying transceiver or a base station of the wireless communication system, wherein the transceiver is configured to report its operating status
event based,
periodically,
threshold based, or
responsive to an operating status reporting request.

21.-23. (canceled)

24. Transceiver according to claim 1,
Wherein the transceiver is configured to report a packet delay budget to a relaying transceiver of the wireless communication system.

25. Relaying transceiver of a wireless communication system,
wherein the relaying transceiver is configured to operate in a sidelink in-coverage, out of coverage or partial coverage scenario,
wherein the relaying transceiver is configured to relay signals between a transceiver and a base station or another transceiver of the wireless communication system,
wherein the relaying transceiver is configured to operate, in dependence on a QoS or/and QoS requirement of the transceiver, using a selected configuration.

26. Relaying transceiver according to claim 25,
wherein the relaying transceiver is configured to receive the selected configuration from a base station of the wireless communication network,
and/or wherein the relaying transceiver is configured to receive the selected configuration via a configuration message.

27. (canceled)

28. Relaying transceiver according to claim 25,
wherein the relaying transceiver is configured to relay the selected configuration to the transceiver,
and/or wherein the selected configuration includes a PC5 configuration and/or a Uu configuration.

29.-30. (canceled)

31. Relaying transceiver according to claim 25,
wherein the selected configuration defines a mapping between Uu and PC5 radio bearers.

32. (canceled)

33. Relaying transceiver according to claim 25,
wherein the QoS requirement is reported from the transceiver to the relaying transceiver,
and/or wherein the relaying transceiver is configured to select a configuration out of the set of configurations in dependence on the QoS requirement of the transceiver, to acquire the selected configuration.

34.-36. (canceled)

37. Relaying transceiver according to claim 25,
wherein the relaying transceiver is configured to signal the selected configuration to the transceiver.

38. Relaying transceiver according to claim 25,
wherein the relaying transceiver is configured to relay signals between the transceiver and the base station using the selected configuration.

39. Relaying transceiver according to claim 25,
wherein the relaying transceiver is configured to provide the set of configurations to the transceiver.

40. Relaying transceiver according to claim 39,
wherein the relaying transceiver is configured to determine at least a part of the set of configurations itself,
and/or wherein the set of configurations are provided to the relaying transceiver by the base station.

41. Relaying transceiver according to claim 25,
wherein the relaying transceiver is configured to update and/or reconfigure one or more configurations of the set of configurations in the transceiver,
and/or wherein the relaying transceiver is configured to update and/or reconfigure one or more configurations of the set of configurations in the transceiver, wherein the relaying transceiver is configured to update and/or reconfigure one or more configurations of the set of configurations in the transceiver
periodically,
event based, or
responsive to a request for reconfiguration received from the transceiver.

42. (canceled)

43. Relaying transceiver according to claim 25,
wherein the relaying transceiver is configured to receive an operating status report from the transceiver,
and/or wherein the relaying transceiver is configured to receive an operating status report from the transceiver, wherein the operating status includes at least one out of
a channel busy ratio, CBR, and/or channel occupancy rate, CR at the transceiver,
a load of the transceiver,
a buffer status of the transceiver,
a queueing latency of the transceiver,
a packet error rate of the transceiver,
a number of HARQ retransmissions of the transceiver,
a measurement report of the transceiver,
and/or wherein the relaying transceiver is configured to report its operating status to the base station of the wireless communication system,
and/or wherein the relaying transceiver is configured to report its operating status to the base station of the wireless communication system, wherein the operating status includes at least one out of
a channel busy ratio, CBR, and/or channel occupancy rate, CR at the relaying transceiver,
a load of the relaying transceiver,
a buffer status of the relaying transceiver,
a queueing latency of the relaying transceiver,
a packet error rate of the relaying transceiver,
a number of HARQ retransmissions of the relaying transceiver,
a measurement report of the relaying transceiver.

44.-65. (canceled)
